(19) United States
(12) Patent Application Publication
(10) Pub. No.: US 2010/0161604 A1
(43) Pub. Date: Jun. 24, 2010

(54) APPARATUS AND METHOD FOR MULTIMEDIA CONTENT BASED MANIPULATION

(75) Inventors: Osnat Mintz, Ramat Hasharon (IL); Leon Portman, Rishon Lezion (IL); Oren Pereg, Amikam (IL); Yuval Lubowich, Raanana (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: Nice Systems Ltd, Raanana (IL)

(21) Appl. No.: 12/342,109

(22) Filed: Dec. 23, 2008

(51) Int. Cl. G06F 7/06; G06F 17/30

(52) U.S. Cl. 707/736; 707/E17.044; 707/E17.014; 707/758

(57) ABSTRACT

An apparatus and methods for generating an ontology for a domain based on analysis performed on interactions captured in the domain. The analysis provides groups of concepts which are used as topics appearing or retrieved from the interactions are used as topics or concepts in the ontology. Concepts belonging to one group are indicated as connected within the ontology. The ontology can then be used in analyzing further interactions and provide meaning, content and relationships between concepts.

### TECHNICAL FIELD

The present invention relates to content derived systems in general, and to an apparatus and method for manipulating of multimedia based on the content therein, in particular.

### BACKGROUND

Large organizations, such as commercial organizations, financial organizations or public safety organizations conduct numerous interactions with customers, users, suppliers or other persons on a daily basis. The interactions include phone calls using all types of phone equipment including landline, mobile phones, voice over IP and others, recorded audio events, walk-in center events, video conferences, e-mails, chats, captured web sessions, captured screen activity sessions, instant messaging, access through a web site, audio segments downloaded from the internet, audio files or streams, the audio part of video files or streams or the like. However, the interactions are largely unorganized, and it is a hard task to gather structured information from such sources in order to obtain insight into the organization.

On the other hand, the concept of ontologies has been quickly spreading around. An ontology is defined as a formal and explicit specification of a shared conceptualization of a domain. An exemplary implementation of an ontology is a semantic network containing concepts associated with a specific domain, and connections between the concepts. An ontology enables the definition and linkage of data so that it can be used by machines for display purposes, as well as for automation, integration and reuse of data across various systems and applications.

An ontology thus provides a shared and common understanding of a particular organization, domain, business vertical, or the like. Ontologies have been widely accepted as an advanced knowledge representation model and have been developed to capture the knowledge of real world domains.

As an exemplary ontology, consider the domain of route planning by a travel agent. The domain comprises the concepts of countries, cities, capital, road, railway, connection, aerial connection, border and others.

The concepts can be arranged in tree-like hierarchy, for example a “road” and a “railway” are particular cases of “connection”.

Each concept can have associated properties, which can be Boolean, numeric, string or another concept or concepts. For example a city can have a property of “in which country is the city”, “number of railway stations”, or others; a country can have a property of “capital city”, “bordering countries”, or the like.

Concepts can be connected, wherein the connection can also have properties. For example, a connection between a city and a country can have the properties of “is the city in the country”, “is the city the capital of the country”, or others.

A connection between two cities can have the properties of “driving distance between the cities”, “public transportation connections existing between the cities”, “how many borders are there between the cities”, or others.

Since ontologies are understandable by humans as well as machines, ontologies provide the ability to share knowledge between people, systems, and in particular computerized systems. In addition, ontologies provide the reusability of domain knowledge, and separation of domain knowledge from operational knowledge.

However, the Achilles heel of ontologies is developing them. This is a tedious job that requires reviewing a lot of material, in addition to intimate knowledge of the relevant domain and related subjects. Therefore a lot of effort is required from a domain expert in order to manually construct an ontology.

These two concepts, of retrieving information from call center interactions, together with ontology development seem related, but there is no known method or apparatus to combine them in order to overcome the disadvantages and problems associated with each of the concepts.

There is thus a need in the art for a method and apparatus that combines analysis of an organization's interactions, with ontologies. The method and apparatus can be useful in retrieving information from the interactions and performing enhanced analytics on the interactions using the domain ontology on the one hand, and facilitating the development of an ontology related to the organization, on the other hand.

### SUMMARY

The disclosure relates to methods and apparatus for combining advanced analysis of interactions captured in an organization, and usage or creation of an ontology related to the organization.

A first aspect of the disclosure relates to a method for enhancing analysis of interactions captured in a call center associated with an organization, the method comprising the steps of: receiving the interactions; extracting data from the interactions; and performing advanced analysis on the interactions or on the data extracted from the interactions, using an ontology related to the organization or to a business vertical with which the organization is associated. The method can further comprise the step of representing results of said analysis together with data from the ontology. The method can further comprise the steps of receiving a query from a user and providing a response to said query, said response comprising data from the advanced analysis. Within the method, said response optionally comprises data from the ontology. The method can further comprise the step of preprocessing the interactions. Within the method the data is optionally extracted from the interactions using one or more analyses selected from the group consisting of: speech to text; word spotting; emotion analysis; and talkover analysis. Within the method the advanced analysis optionally comprises activating one or more analyses selected from the group consisting of: data mining; text mining; root cause analysis; link analysis, contextual analysis; text clustering; pattern recognition; hidden pattern recognition; a prediction algorithm; semantic mapping; natural language processing analysis; and Online analytical processing cube analysis. Within the method, the data extraction step optionally uses data related to the interactions. Within the method, the data related to the interactions is optionally selected from the group consisting of: CTI data; CRM data; and billing data. Within the method, the advanced analysis step optionally uses additional data. Within the method, the additional data is optionally selected from the group consisting of: content from a web site of the organization; internal glossary; internal dictionary; a document of the organization; marketing material; competition analysis, and a broadcast. The method can further comprise the step of updating the domain ontology based on results obtained by the advanced analysis.

Another aspect of the disclosure relates to a method for generating a domain ontology in an organization from interactions captured in a call center associated with the organization, the method comprising the steps of: receiving the interactions; extracting data from the interactions; performing advanced analysis on the interactions or on the data extracted from the interactions; and creating the domain ontology or enhancing a previous domain ontology using output of the advanced analysis. Within the method, the advanced analysis step optionally utilizes the previous domain ontology. The method can further comprise the step of storing the ontology. Within the method, the ontology is optionally stored in a format selected from the group consisting of: plain text; XML; and Web Ontology Language.

Yet another aspect of the disclosure relates to an apparatus for generating a domain ontology in an organization from interactions captured in a call center associated with the organization, the apparatus comprising: an extraction component arranged to extract data from the interactions; an advanced analysis engine arranged to perform advanced analysis on the interactions or data extracted by the extraction component, and to obtain a group of concepts, the advanced analysis using a domain ontology. The apparatus can further comprise a preprocessing engine arranged to perform preprocessing on the interactions. Within the apparatus, the extraction component is optionally selected from the group consisting of: a speech to text engine; a word spotting engine; an emotion analysis engine; and a talkover analysis engine. Within the apparatus, the advanced analysis engines optionally comprise one or more engine selected from the group consisting of: a data mining engine; a text mining engine: a root cause analysis engine; a link analysis engine; a contextual analysis engine; a text clustering engine; a pattern recognition engine; a hidden pattern recognition engine; a prediction engine; a semantic mapping engine; a natural language processing engine; and an Online analytical processing cube analysis engine. Within the apparatus, the extraction component optionally receives data related to the interactions. Within the apparatus, the data related to the interactions is optionally selected from the group consisting of: CTI data, CRM data; and billing data. Within the apparatus, the advanced analysis engine optionally receives additional data. Within the apparatus, the additional data is optionally selected from the group consisting of: content from a web site of the organization, internal glossary; internal dictionary; a document of the organization, marketing material; competition analysis; and a broadcast. The apparatus can further comprise a manual generation or modification component for generating the existing ontology or modifying the ontology. The apparatus can further comprise a query engine for receiving a query and generating a response related to the group of concepts or the ontology. The apparatus can further comprise a management component for controlling flow and data transfer between components. The apparatus can further comprise a capturing component for capturing the interactions, and a storage device for storing the ontology or results obtained by the advanced analysis engine.

Yet another aspect of the disclosure relates to an apparatus for generating a domain ontology in an organization from interactions captured in a call center associated with the organization, the apparatus comprising: an extraction component arranged to extract data from the interactions; an advanced analysis engine arranged to perform advanced analysis on the interactions or data extracted by the extraction component, and to obtain a group of concepts; an ontology generation or enhancement component arranged to generate an ontology or modify an existing ontology utilizing the group of concepts; and a storage device for storing the ontology. Within the apparatus, the advanced analysis engine optionally receives the existing ontology.

Yet another aspect of the disclosure relates to a computer readable storage medium containing a set of instructions for a general purpose computer, the set of instructions comprising: receiving the interactions; extracting data from the interactions; and performing advanced analysis on the interactions or on the data extracted from the interactions, using an ontology related to the organization or to a business vertical with which the organization is associated.

Yet another aspect of the disclosure relates to a computer readable storage medium containing a set of instructions for a general purpose computer, the set of instructions comprising: receiving interactions captured in a call center associated with an organization; extracting data from the interactions; performing advanced analysis on the interactions or on the data extracted from the interactions; and creating a domain ontology or enhancing a previous domain ontology using output of the advanced analysis.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a block diagram of the main components in a typical environment in which the disclosed method and apparatus are used;

FIG. 2 is a flowchart of the main steps in a method for creating or enhancing ontologies, in accordance with the disclosure;

FIG. 3 is a flowchart of the main steps in a method for interaction analysis using ontologies, in accordance with the disclosure; and

FIG. 4 is a block diagram of the main components in an apparatus for analysis of interactions and crating or modifying ontologies, in accordance with the disclosure.

### DETAILED DESCRIPTION

An apparatus and method for combining the analysis of audio interactions captured within an organization, with developing an ontology for the call center. The combination is beneficial to both tasks, since the ontology is initially developed on the basis of an analyzed corpus of interactions, and analysis benefits from an ontology as a basis.

Thus, an initial corpus of interactions is received and analyzed. The analysis includes extracting data and meta data, including speech to text extraction, emotion analysis, CTI information, and the like. The data and meta data undergo advanced analysis, including for example link analysis, root cause analysis, contextual analysis, and the like. The result of the advanced analysis comprises concepts related to the domain. The concepts are organized in groups, wherein each group contains related concepts as discovered during the advanced analysis. The group structure, including data from interactions assigned to the is same group and interconnections between groups, may then be used to construct an initial ontology of concepts associated with the environment. Alternatively, if an ontology related to the organization is already available, it can be used to enhance the advanced analysis. The analysis results can then be used to enhance the ontology rather than start it.

The newly generated, or enhanced ontology is then used for analyzing further interactions and enhancing insights received from the interactions.

It will be appreciated that the generated ontology can be used for further purposes and not only towards analyzing future interactions.

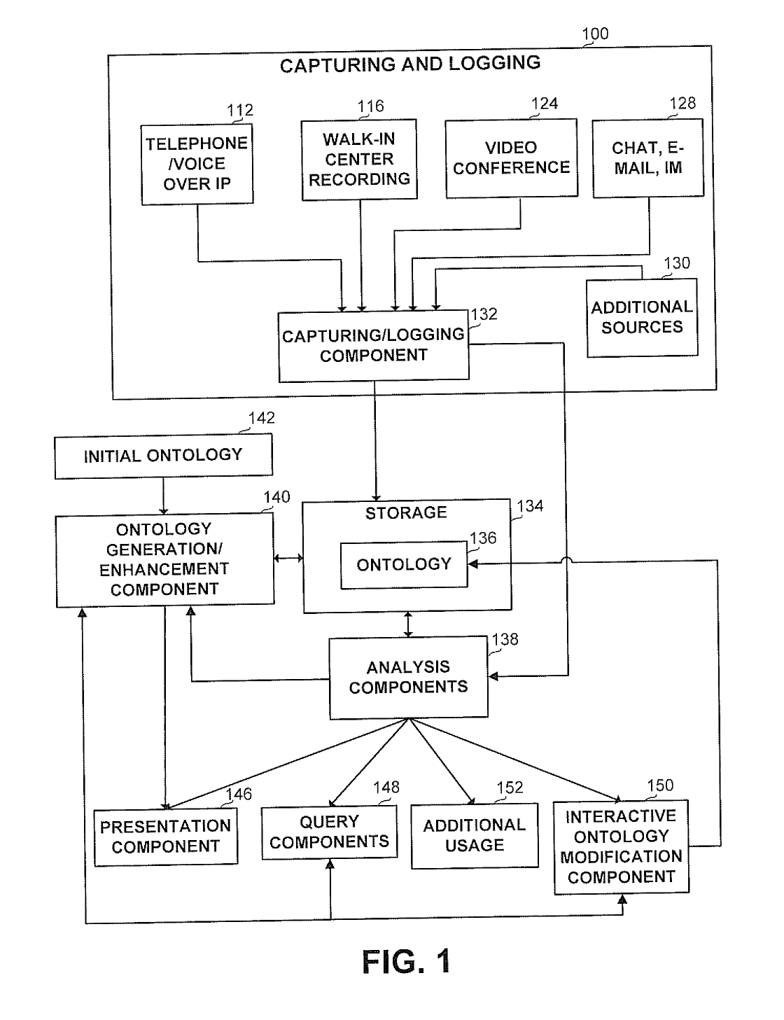

Referring now to FIG. 1, showing a typical environment in which the disclosed method and apparatus are used

The environment is preferably an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including broadcasts, interactions with customers, users, organization members, suppliers or other parties are captured, thus generating input information of various types. The information types optionally include auditory segments, video segments, textual interactions, and additional data. The capturing of voice interactions, or the vocal part of other interactions, such as video, can employ many forms, formats, and technologies, including trunk side, extension side, summed audio, separate audio, various encoding and decoding protocols such as G729, G726, G723.1, and the like. The interactions are captured using capturing or logging components 100. The vocal interactions usually include telephone or voice over IP sessions 112. Telephone of any kind, including landline, mobile, satellite phone or others is currently the main channel for communicating with users, colleagues, suppliers, customers and others in many organizations. The voice typically passes through a PABX (not shown), which in addition to the voice of two or more sides participating in the interaction collects additional information discussed below. A typical environment can further comprise voice over IP channels, which possibly pass through a voice over IP server (not shown). It will be appreciated that voice messages are optionally captured and processed as well, and that the handling is not limited to two- or more sided conversation. The interactions can further include face-to-face interactions, such as those recorded in a walk-in-center 116, video conferences 124, textual sources such as chat, e-mail, instant messaging, web sessions and others 128, and additional data sources 128. Additional sources 128 may include vocal sources such as microphone, intercom, vocal input by external systems, broadcasts, files, broadcasts, or any other source. Additional sources may also include non vocal sources such as screen events sessions, facsimiles which may be processed by Object Character Recognition (OCR) systems, or others.

Data from all the above-mentioned sources and others is captured and preferably logged by capturing/logging component 132. Capturing/logging component 132 comprises a computing platform executing one or more computer applications as detailed below. The captured data is optionally stored in storage 134 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization. A part of, or storage additional to storage 134 is storage 136 which stores one or more ontologies, in any acceptable format such as plain text, XML, Web Ontology Language (OWL), or any other format. Storage 134 can comprise a single storage device or a combination of multiple devices.

The apparatus further comprises analysis components 138 which comprise all analysis components used, including data extraction engines such as but not limited to: speech to text engine, word spotting engine, emption analysis engine, call flow analysis engine. Analysis components 138 further comprise advanced analysis engines, such as engines for data mining, text mining, root cause analysis; link analysis, contextual analysis; text clustering, pattern recognition, hidden pattern recognition, a prediction algorithm, semantic mapping, NLP analysis, OLAP cube analysis and others.

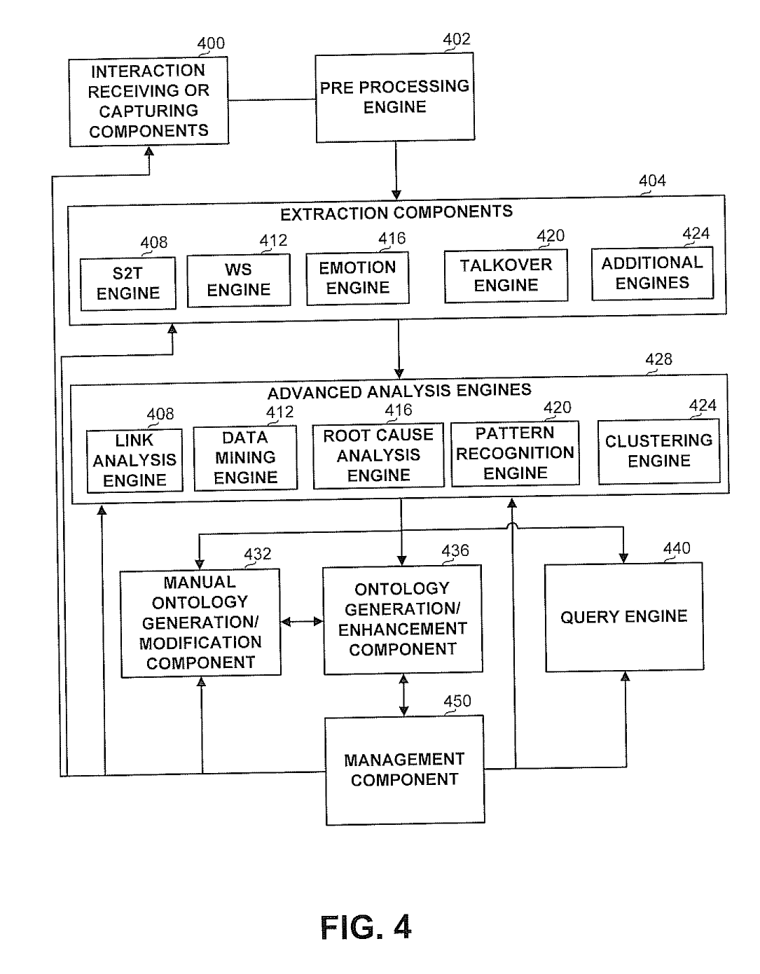

The apparatus further comprises ontology generation or enhancement component 140 for generating an ontology from input such as interaction and data groups. Ontology generation or enhancement component optionally uses an initial ontology 142 as a basis. Initial ontology 142 may relate to the organization, its domain, field or vertical business. Analysis components 138 and ontology generation or enhancement component 140 are further detailed in association with FIG. 4 below.

The output of analysis component 138 and optionally additional data are preferably sent to multiple destinations, including but not limited to presentation component 146 for presentation of the data and/or associated ontologies in any way the user prefers, including for example various graphic representations, textual presentation, table presentation, vocal representation, or the like, and can be transferred in any required method, including showing on a display device, sending a report, or others. The results can further be transferred to query component 148, which can generate responses to queries related to the ontology or other data associated with the system. The results are optionally transferred also to interactive ontology modification component 150 which comprises user interface and additional functionality required for manually modifying an ontology, by adding deleting, or changing concepts or connections thereof. The ontology modification component results can be stored in storage 136 or fed back and ontology generation or modification component 140. The results can also be transferred to additional usage components 152, if required. Such components may include playback components, report generation components, alert generation components, or others.

The apparatus preferably comprises one or more computing platforms, executing components for carrying out the disclosed steps. The computing platform can be a general purpose computer such as a personal computer, a mainframe computer, or any other type of computing platform that is provisioned with a memory device (not shown), a CPU or microprocessor device, and several I/O ports (not shown). The components are preferably components comprising one or more collections of computer instructions, such as libraries, executables, modules, or the like, programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The software components can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

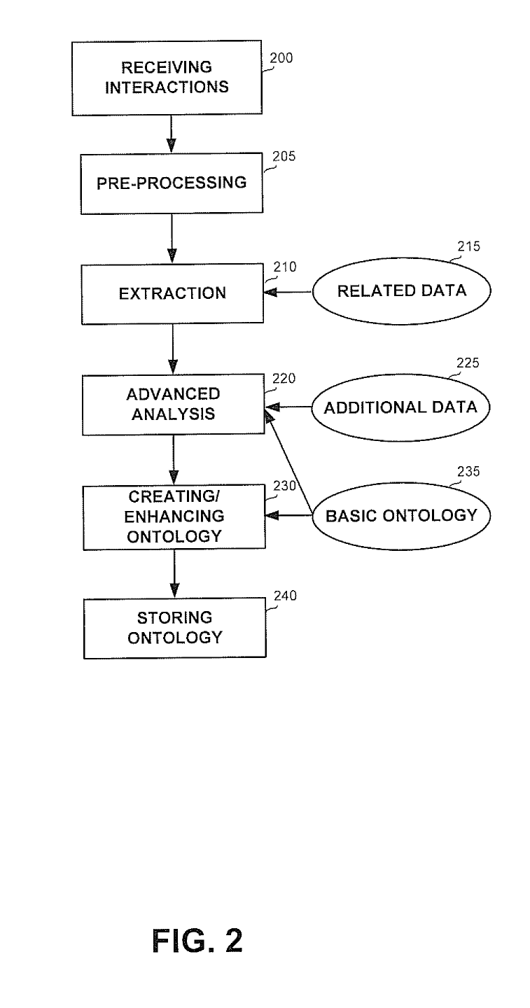

Referring now to FIG. 2 showing a flowchart of the main steps in a method for ontology generation using interactions.

The method starts on interaction receiving step 200, in which captured or logged interactions are received for processing. The interaction collection should characterize as closely as possible the interactions regularly captured at the environment.

On optional step 205, the interactions received on step 200, and in particular the vocal interactions or the vocal part of interactions, optionally undergo preprocessing, such as speaker separation, noise reduction, silence removal, or the like.

On step 210, data is extracted from the interactions. The data extraction may involve one or more steps or types of text extraction, such as speech to text or word spotting. Speech to text is directed to transcribing a vocal signal and outputting the spoken text, while word spotting is directed to identifying words from a precompiled list of words which are significant to the organization. Extraction can further obtain additional data, such as positive or negative emotion indication, sentiment analysis, call flow analysis data, or others. The extraction step optionally uses related data 215, which includes data external to the interactions, such as CTI, CRM, billing or other data, word list for word processing, or others.

On step 220 advanced analysis is performed over the interactions and the data extracted on step 210. Step 220 optionally uses additional data 225 or basic ontology 235. Additional data 225 can comprise textual or other data related to the organization, such as content from the web site of the organization including internal glossaries and dictionaries, documents of the organization which can include marketing material or competitions analysis, broadcasts, or any other material. Optionally, such material can also undergo an extraction step, for example transcribing a broadcast.

Advanced analysis step 220 activates advanced engines for extracting insights from the interactions. The engines used during advanced analysis step 220 may include but are not limited to data mining, text mining, root cause analysis, link analysis, contextual analysis, text clustering, pattern recognition, hidden pattern recognition, prediction algorithms, semantic mapping, Natural Language Processing (NLP), Online analytical processing (OLAP) cube analysis, or others. The output of the advanced analysis step 220 comprises concepts related to the domain. The concepts are organized in groups, wherein each group contains related concepts as discovered during analysis. It will be appreciated that concepts may belong to one or more groups, and that connections may also exist between groups or between concepts belonging to different groups.

Advanced analysis step 220 optionally receives basic ontology 235, which may be created by an organization domain expert or received from an external source, and is useful in the analysis.

The group structure and connections as generated during advanced analysis step 220 are then transferred to creating/enhancing ontology step 230. Creating/enhancing ontology step 230 optionally receives also basic ontology 235, in which case the ontology is enhanced, while otherwise a new ontology is created. During creating/enhancing ontology step 230, a domain expert constructs the ontology by using the automatically generated groups of concepts. The domain expert may add, delete or change concepts, their attributes, logical relations or connections between the concepts, relative weight of the connections, and the structure of the ontology. Preferably, the expert reviews the ontology as defined by the groups and uses the groups of concepts automatically generated on advanced analysis step 220 in order to evaluate the ontology and update it. The domain expert may use any proprietary or standard tools for creating or editing the ontologies such as protégé developed by Stanford Center for Biomedical Informatics Research at the Stanford University School of Medicine (http://protege.stanford.edu), OntoStudio developed by ontoprise GmbH, An der RaumFabrik 29, D-76227 Karlsruhe, Germany (http://www.ontoprise.de), or others, any dedicated tool.

On storing ontology step 240 the ontology is stored in a storage device, in any required format, such as in a relational or any other database, a text file, XML file, Web Ontology Language (OWL) file, or any other format or storage method.

It will be appreciated that the method described in association with FIG. 2 can be employed in an iterative manner, in which a created or updated ontology is used by further activations of advanced analysis step 220 using further interactions, and the further activations of creating/enhancing ontology step 230 are performed using the advanced analysis results.

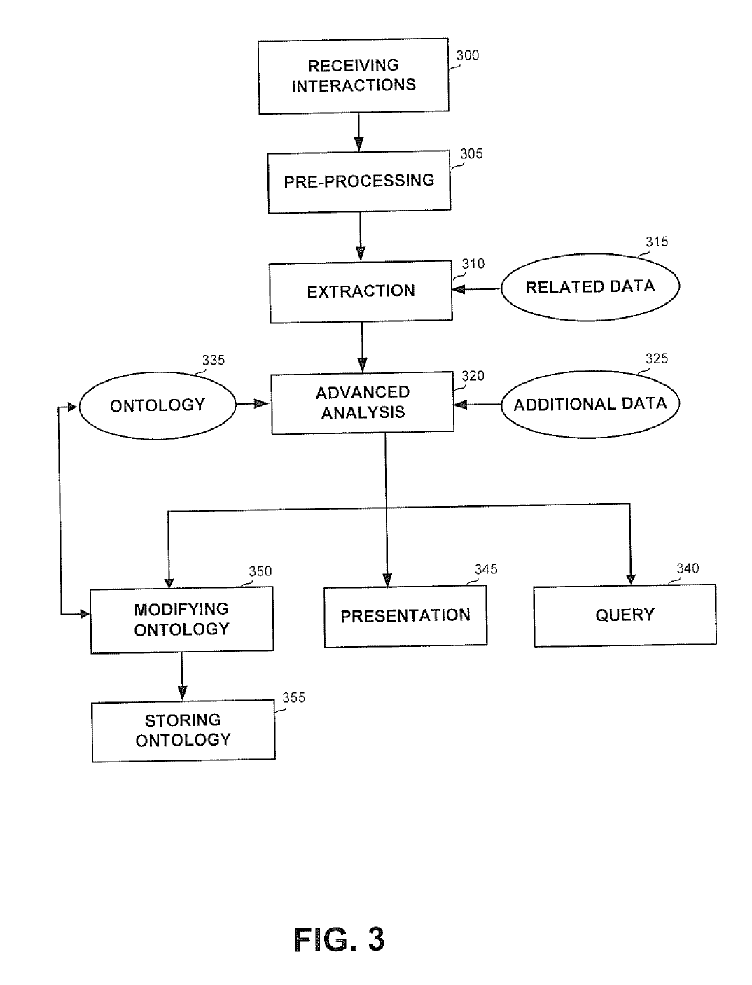

Referring now to FIG. 3, describing a flowchart of the main steps in a method for interaction analysis using ontologies. The general idea of the method relates to using an ontology, whether created on step 230 of FIG. 2 or any other one, in order to enhance the analysis with additional knowledge, such as additional entities, relationships and relationship types.

Interaction receiving step 300, preprocessing step 305, extraction step 310 using related data 315, and additional data 325 are analogous to Interaction receiving step 200, preprocessing step 205, extraction step 210 using related data 215, and additional data 225 of FIG. 2, respectively.

On step 320 advanced analysis is performed on the interactions, optionally using additional data 325. Advanced analysis step 320 comprises activating engines, which may include but are not limited to any of the following: data mining, text mining, root cause analysis, link analysis, contextual analysis, text clustering, pattern recognition, hidden pattern recognition, prediction algorithms, semantic mapping, NLP analysis, OLAP cube analysis, or others.

The output of the various engines is combined with existing ontology 335. Ontology 335 provides representation of the organization's domain or parts thereof, or of the business field or vertical the organization is related to, such as “cellular communication”, and is used for enhancing the engines' output with semantic meanings. Thus, for example, the ontology can indicate that two product names are actually one product branded differently, or that one offered service is an extension of another service, or the like. Ontology 335 is also useful in removing irrelevant concepts from the output, adding relations between concepts and obtaining logical deductions from the outputs. For example, the results provided by the link analysis engine can be enhanced by adding, the type of relationships between the entities, such as “similar to”, “type of”, “a derivative of”, or the like. For example, the topic “no answer” will have a “type of” relation with the topic of “bad service”. More complicated relations can be deduced using relation attributes such as transitivity, commutatively, or the like. For example if the ontology contains information about the competitors and their promotion campaigns, it can be deduced that interactions that contain promotion campaign details of the competitors should be treated as interactions that contain the competitor name, even though the name of the competitor is not mentioned explicitly.

Ontology 335 can be received from any source, and in particular can be generated during creating/enhancing ontology step 230 of FIG. 2.

The results of advanced analysis step 320 as enhanced by ontology 335 can be used in a variety of ways. For example, the results can be queried on query step 340, in which a user, a machine or a computer application can issue a semantic query on specific results. For example: who are the competitors of the organization, in which interactions is a competitor mentioned, or the like. A response to the query is then provided to the user, which includes terms related to the analysis, and optionally terms related to the ontology as well.

The domain ontology, together with the advanced analysis results, provides the data and relationship for the query engine. The query call be issued and the response received in any available format, such as SQL, WOL query, or the like.

The analysis results and ontology can be used on presentation step 345, in which the results are presented to a user together with the information from the ontology, so that the presentation enables the user to better grasp the results of the analysis. For example, if a concept is a “type of” another concept, then adding this information to the result presentation enhances the understanding of the analysis results. The presentation can take any form such as text files, graphic presentation, tables, or the like. For example, clustering results can be presented as a topic graph in which the topics are represented as vertices, and the semantic relations between topics as discovered from the ontology are presented as edges, or the like. The presentation optionally demonstrates to a user various insights, needs, aspects of the organization or the field or vertical of the organization, such as business, administrative, organizational, financial or other aspects, or the like. The presentation can also include or connect to additional options, such as playback, reports, quality monitoring systems, or others.

The analysis results and ontology can be used on ontology modification step 350, in which ontology 335 is modified based on the results of advanced analysis step 320. Modifying the ontology can be performed similarly to enhancing the modification detailed in association with step 230 of FIG. 2. The ontology modification is optionally performed only by a user with sufficient privileges. The user is presented with options to modify, add, delete, enhance, or otherwise change the concepts and relations in the ontology, based on his or her knowledge or according to the presented results.

On step 355 the modified ontology is stored on any associated storage device and in any required format.

It will be appreciated that the method described in association with FIG. 3 can be employed in an iterative manner, in which the ontology is further updated as more interactions are analyzed and more times ontology modification step 350 is repeated. The method preferably continues until ontology 335 is sufficient to a user.

It will also be appreciated that the method described in association with FIG. 2 and FIG. 3 above can be employed in conjunction and in an iterative manner. Thus, an initial ontology can be generated using the results of interaction analysis. The initial ontology can then be used in further activations of advanced analysis step 220 using further interactions, and the results of the analysis can be used in further activations of creating/enhancing ontology step 230 to improve the ontology.

Referring now to FIG. 4, showing a block diagram of the main components in an apparatus for interaction sectioning, in accordance with the disclosure.

The apparatus implements analysis component 138, ontology generation/enhancement component 140, and interactive ontology modification component 150 of FIG. 1. The components of the apparatus are thus preferably software units such as modules, executables, libraries or the like.

The apparatus comprises interaction receiving or capturing components 400, arranged to capture or receive interactions from a storage device, a capture device, or from another source. The apparatus further comprises preprocessing component 402 arranged to perform preprocessing on the interactions, and particularly the vocal interactions, including for example noise reduction, speaker separation of the like.

The apparatus comprises extraction components 404, arranged to extract data and meta data from the interactions, and in particular from their audio part. Extraction components 404 optionally comprise speech to text engine 408 arranged to transcribe an audio file and output as accurate as possible transcription of the audio signal; word spotting (WS) engine 412 designed to spot words out of a pre-compiled list in an audio signal; emotion detection engine 416 arranged to identify areas within an audio signal containing positive or negative emotions by the agent or the customer; talkover engine 420 arranged to identify silence areas, talkover areas, areas in which the agent or the customer speaks, areas in which the agent or the customer barge into the other person's speech, or the like; and additional engines 424 designed to extract additional information related to the interaction, such as number and timing of hold, transfer, or any other information.

The apparatus further comprises advanced analysis engines 428 arranged to perform advanced analysis on the interactions or data extracted by components 404, and in particular advanced analysis on textual or database information. The engines may include link analysis engine 408, data mining engine 412, root cause analysis engine 416, pattern recognition engine 420, clustering engine 424, or others, such as text mining; contextual analysis engine; text clustering engine; hidden pattern recognition engine; a prediction engine; semantic mapping engine; NLP engine, and OLAP cube analysis engine or others. A person skilled in the art will appreciate that any subset of the detailed engines or additional ones can be used, and the engines can be activated in any required order. Thus, one or more of the engines can analyze the interactions, the data extracted by extraction components 404 or the output of any of the other advanced analysis engines. It will also be appreciated that two or more of the detailed analysis types can be performed by one engine.

The apparatus further comprises manual ontology generation/modification component 432 which comprises a user interface and provides a user the option to define a basic ontology or change or enhance an existing ontology. A user can thus add, delete or change a subject or topic in the ontology, add, change or delete a connection or relation between topics, change the connection type or relative weight of connections, or the like.

The apparatus further comprises ontology generation/modification component 436 which receives the output of advanced analysis engines 428, and in particular groups of concepts and generates an ontology or enhances an existing ontology based on the output. The topics in the groups can be objects in the ontology, and concepts assigned to one group can be translated to connections between such objects.

Yet other components in the apparatus include query engine 440 arranged to query an ontology or groups of concepts for its objects and relations thereof, or query interactions in a semantic manner for example: find interactions that contains my competitors, since the competitors will be part of the ontology there will be no need to enter the competitors names in the query and it enables to query in a more “natural” language, and management component 450, arranged to activate the various engines and components, and control the flow and data transfer among them or to and from other components of the apparatus of FIG. 1, such as capture and storage devices.

It will be appreciated by a person skilled in the art that the disclosed apparatus is exemplary only and that multiple other implementations can be designed without deviating from the disclosure. It will be further appreciated that multiple other components and in particular extraction and analysis engines can be used. The components of the apparatus can be implemented using proprietary, commercial or third party products.

The disclosure relates to methods and apparatus for using interaction analysis performed on interactions from a domain, to generate or enhance an ontology related to the domain. On the other hand, the methods and apparatus also use an existing ontology for obtaining better results from the analysis. Both directions provide better understanding of the domain. On one hand, the results of the interaction analysis thus provide better representation of the interactions, including subjects, trends, problems and other issues raised in the interactions. On the other hand, the enhanced ontology is based on real events that occurred in the organization, so that the subjects and connections thereof represent the organization in a realistic manner.

It will be appreciated that any of the used, constructed or enhanced ontologies or domain ontologies may relate to the call center, the organization, the domain of the organization, its field or vertical business.

It will be appreciated by persons skilled in the art that the present invention is not limited to what has been particularly shown and described hereinabove. Rather the scope of the present invention is defined only by the claims which follow.

What is claimed is:

1. A method for enhancing analysis of interactions captured in a call center associated with an organization, the method comprising the steps of:
receiving the interactions:
extracting data from the interactions; and
performing advanced analysis on the interactions or on the data extracted from the interactions, using an ontology related to the organization or to a business vertical with which the organization is associated.

2. The method of claim 1 further comprising the step representing results of said analysis together with data from the ontology.

3. The method of claim 1 further comprising the steps of receiving a query from a user and providing a response to said query, said response comprising data from the advanced analysis.

4. The method of claim 3 wherein said response comprises data from the ontology.

5. The method of claim 1 further comprising preprocessing the interactions.

6. The method of claim 1 wherein the data is extracted from the interactions using at least one analysis selected from the group consisting of: speech to text; word spotting; emotion analysis; sentiment analysis; and talkover analysis.

7. The method of claim 1 wherein the advanced analysis comprises activating at least one analysis selected from the group consisting of: data mining; text mining; root cause analysis; link analysis, contextual analysis; text clustering; pattern recognition; hidden pattern recognition; a prediction algorithm; semantic mapping; natural language processing analysis; and Online analytical processing cube analysis.

8. The method of claim 1 wherein data extraction step uses data related to the interactions.

9. The method of claim 8 wherein the data related to the interactions is selected from the group consisting of: CTI data; CRM data; and billing data.

10. The method of claim 1 wherein the advanced analysis step uses additional data.

11. The method of claim 10 wherein the additional data is selected from the group consisting of: content from a web site of the organization; internal glossary; internal dictionary; a document of the organization; marketing material; competition analysis, and a broadcast.

12. The method of claim 1 further comprising updating the domain ontology based on results obtained by the advanced analysis.

13. A method for generating a domain ontology in an organization from interactions captured in a call center associated with the organization, the method comprising the steps of:
receiving the interactions;
extracting data from the interactions;
performing advanced analysis on the interactions or on the data extracted from the interactions; and
creating the domain ontology or enhancing a previous domain ontology using output of the advanced analysis.

14. The method of claim 13 wherein the advanced analysis step utilizes the previous domain ontology.

15. The method of claim 13 further comprising the step of storing the ontology.

16. The method of claim 15 wherein the ontology is stored in a format selected from the group consisting of: plain text; XML; and Web Ontology Language.

17. An apparatus for enhancing analysis of interactions in an organization from interactions captured in a call center associated with the organization, the apparatus comprising:
an extraction component arranged to extract data from the interactions;
an advanced analysis engine arranged to perform advanced analysis on the interactions or data extracted by the extraction component, and to obtain a group of concepts, the advanced analysis using a domain ontology.

18. The apparatus of claim 17 further comprising a preprocessing engine arranged to perform preprocessing on the interactions.

19. The apparatus of claim 17 wherein the extraction component is selected from the group consisting of: a speech to text engine; a word spotting engine; an emotion analysis engine; and a talkover analysis engine.

20. The apparatus of claim 17 wherein the advanced analysis engines comprise at least one engine selected from the group consisting of: a data mining engine; a text mining engine; a root cause analysis engine; a link analysis engine; a contextual analysis engine; a text clustering engine; a pattern recognition engine; a hidden pattern recognition engine; a prediction engine; a semantic mapping engine; a natural language processing engine; and an Online analytical processing cube analysis engine.

21. The apparatus of claim 17 wherein the extraction component receives data related to the interactions.

22. The apparatus of claim 21 wherein the data related to the interactions is selected from the group consisting of: CTI data; CRM data; and billing data.

23. The apparatus of claim 17 wherein the advanced analysis engine receives additional data.

24. The apparatus of claim 23 wherein the additional data is selected from the group consisting of: content from a web site of the organization, internal glossary; internal dictionary; a document of the organization, marketing material; competition analysis; and a broadcast.

25. The apparatus of claim 17 further comprising a manual generation or modification component for generating the existing ontology or modifying the ontology.

26. The apparatus of claim 17 further comprising a query engine for receiving a query and generating a response related to the group of concepts or the ontology.

27. The apparatus of claim 17 further comprising a management component for controlling flow and data transfer between components.

28. The apparatus of claim 17 further comprising:
a capturing component for capturing the interactions; and
a storage device for storing the ontology or results obtained by the advanced analysis engine.

29. An apparatus for generating a domain ontology in an organization from interactions captured in a call center associated with the organization, the apparatus comprising:
an extraction component arranged to extract data from the interactions;
an advanced analysis engine arranged to perform advanced analysis on the interactions or data extracted by the extraction component, and to obtain a group of concepts;
an ontology generation or enhancement component arranged to generate an ontology or modify an existing ontology utilizing the group of concepts; and
a storage device for storing the ontology.

30. The apparatus of claim 29 wherein the advanced analysis engine receives the existing ontology.

31. A computer readable storage medium containing a set of instructions for a general purpose computer, the set of instructions comprising:
receiving the interactions:
extracting data from the interactions; and
performing advanced analysis on the interactions or on the data extracted from the interactions, using an ontology related to the organization or to a business vertical with which the organization is associated.

32. A computer readable storage medium containing a set of instructions for a general purpose computer, the set of instructions comprising:
receiving interactions captured in a call center associated with an organization;
extracting data from the interactions;
performing advanced analysis on the interactions or on the data extracted from the interactions; and
creating a domain ontology or enhancing a previous domain ontology using output of the advanced analysis.
